(19) United States
(12) Patent Application Publication
(10) Pub. No.: US 2011/0299590 A1
(43) Pub. Date: Dec. 8, 2011

(54) ERROR RESILIENT CODING METHOD USING ADAPTIVE ADDITIONAL IMAGE INFORMATION

(76) Inventors: Ju Hun Nam, Gyeonggi-do (KR); Woon Moon Lee, Seoul (KR); Sung Hoon Yun, Gyeonggi-do (KR); Jin Hyung Kim, Seoul (KR); Sung Jea Ko, Seoul (KR)

(21) Appl. No.: 13/024,125

(22) Filed: Feb. 9, 2011

(30) Foreign Application Priority Data
Feb. 10, 2010 (KR) 10-2010-0012545

(51) Int. Cl. H04N 7/26

(52) U.S. Cl. 375/240.02; 375/E07.126

(57) ABSTRACT

An error resilient coding method using adaptive additional image information is provided comprising determining a priority order of header data, adaptively configuring additional image information according to the priority order, and coding the additional image information and adding the coded additional image information to original image information.

### CROSS-REFERENCE TO RELATED APPLICATION

This application claims priority to Korean Patent Application No. 2010-0012545 filed on Feb. 10, 2010, the contents of which are herein incorporated by reference in its entirety.

### BACKGROUND

1. Technical Field

Embodiments of the present invention related to an error resilient coding method, and more specifically to an error resilient coding method that adaptively adjusts the amount of additional image information to restore a distortion of a received video with a minimum amount of additional image information.

2. Discussion of the Related Art

Errors occur during data communication using various terminals or between different types of networks. To address error problems, a diversity of error restoration schemes have been developed, such as motion-compensated prediction (MCP), forward error correction (FEC), infra frame or macroblock refresh, or reference picture selection (RPS). However, the above-listed error restoration schemes have a few disadvantages, and thus, additional information coding methods have been developed to overcome the disadvantages.

The additional information coding methods do not require feedback information and may prevent error propagation and increase of bit streams. However, the additional information coding methods cannot adjust the amount of additional image information and may use only predetermined additional image information.

Therefore, there is a need for an error resilient coding method that may adaptively adjust the amount of additional image information to restore a distortion of a received video.

### SUMMARY

Exemplary embodiments of the present invention provide an error resilient coding method that may effectively restore a distortion of a received video with the minimum amount of additional video information by adaptively adjusting the amount of additional video information, and may minimize distortions based on a degree of image distortion that is predicted by error modeling.

According to an embodiment of the present invention, there is provided an error resilient coding method using adaptive additional image information, comprising determining a priority order of header data, adaptively configuring additional image information according to the priority order, and coding the additional image information and adding the coded additional image information to original image information.

According to an embodiment, the error resilient coding method further comprises determining whether the image information exceed a predetermined amount of data.

According to an embodiment, determining the priority order of header data includes predicting a distortion of an entire group of pictures (“GOP”).

According to an embodiment, determining the priority order of header data is performed by predicting a distortion of a frame using a result of a predicted distortion of the entire GOP.

According to an embodiment, the distortion of the frame is predicted based on a following equation: ΔDₜₒₜₐₗ(m)=[L−m−p(L−m−1)]ΔDₚ(m) (where, m refers to a frame number, L refers to the number of frames included in a GOP, p refers to a packet loss rate, and ΔDₚ(m) refers to a distortion of an mth frame due to error propagation, and ΔDₜₒₜₐₗ(m) refers to a distortion of the mth frame), wherein the priority order of the header data is determined according to a size of the predicted distortion.

According to an embodiment, determining the priority order of the header data includes predicting O(m) based on a following equation:

$$O ( m ) = \frac{Δ {D}_{total} ( m )}{R ( m )}$$

(where, ΔDₜₒₜₐₗ(m) refers to a distortion of the mth frame, R(m) refers to the number of coded bits of header data in the mth frame, and O(m) refers to ΔDₜₒₜₐₗ(m) with respect to R(m)), wherein a higher O(m) value has a higher priority order of the header data.

According to an embodiment, coding the additional image information and adding the coded additional image information to original image information includes adjusting the amount of the additional image information to be within a channel capacity range.

The embodiments of the present invention may be applied to various digital video codec standards and have a diversity of applications, such as broadcast systems and image transmitting devices.

### BRIEF DESCRIPTION OF THE DRAWINGS

The embodiments of the present invention will become readily apparent by reference to the following detailed description when considered in conjunction with the accompanying drawings, wherein:

FIG. 1 is a flowchart illustrating an error resilient coding method using adaptive additional image information according to an embodiment of the present invention;

FIG. 2 is a view illustrating a construction of a partition when an error resilient coding method according to an embodiment of the present invention is applied to H.264;

FIG. 3 is a view illustrating an example where a transmission error of an image is propagated;

FIG. 4 is a view illustrating additional image information is configured when an error resilient coding method using adaptive additional image information according to an embodiment of the present invention is applied to H.264;

FIGS. 5A, 5B, and 5C are images obtained by application of an error resilient coding method using adaptive additional image information according to an embodiment of the present invention; and

FIGS. 6A and 6B are graphs illustrating PSNRs obtained by application of an error resilient coding method using adaptive additional image information according to an embodiment of the present invention.

### DESCRIPTION OF THE EMBODIMENTS

Hereinafter, embodiments of the present invention will be described in detail with reference to the accompanying drawings.

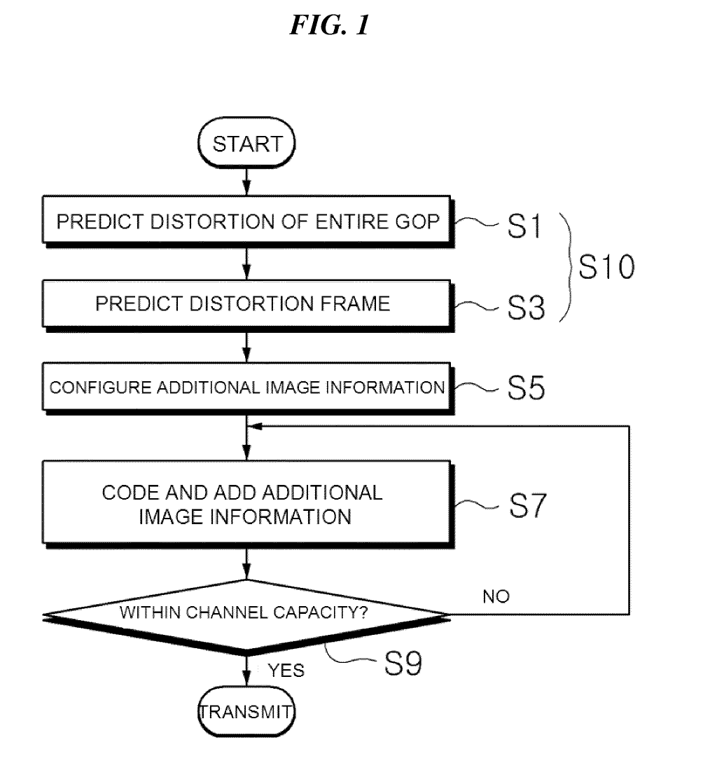

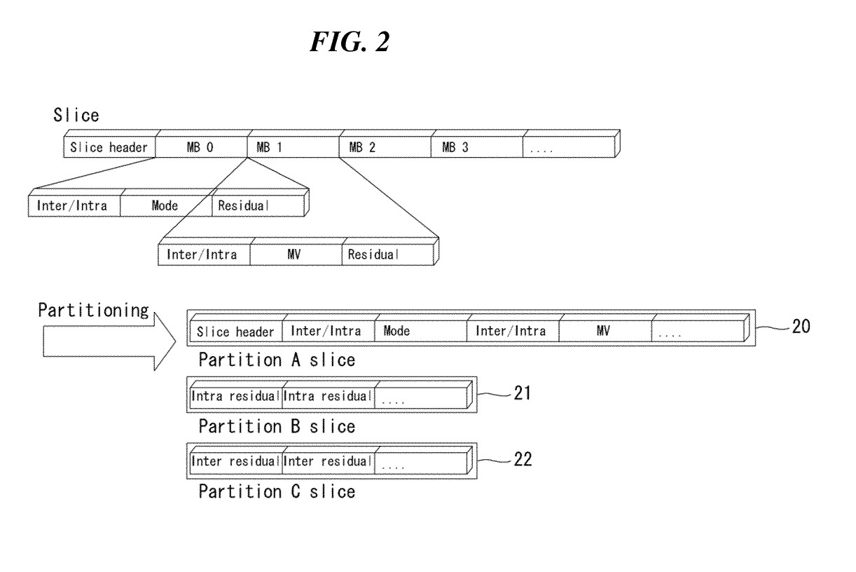

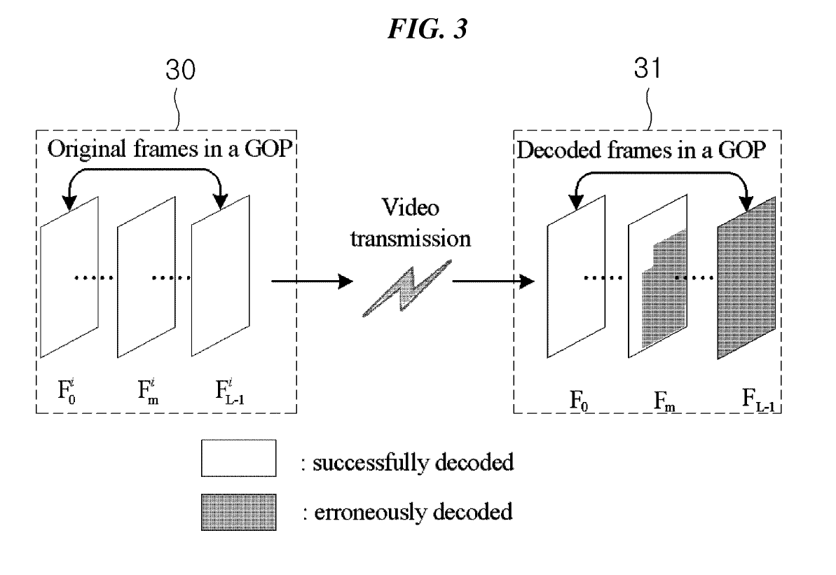

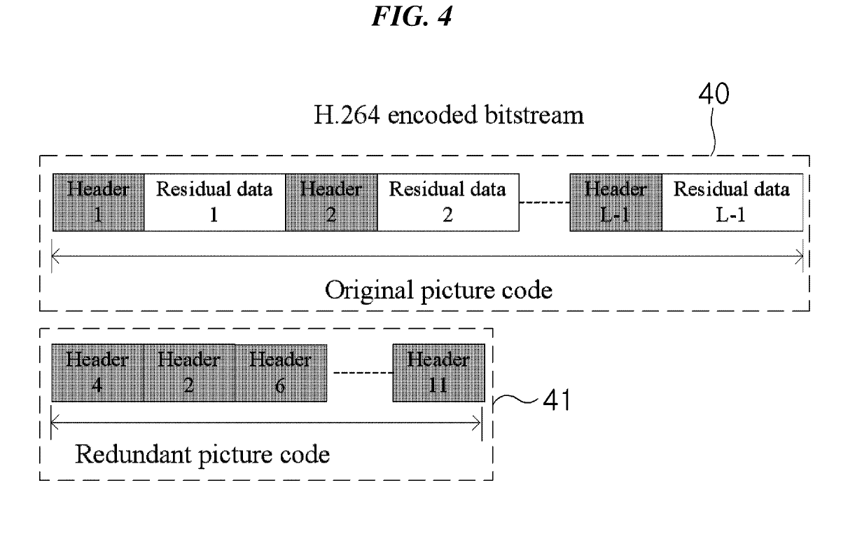

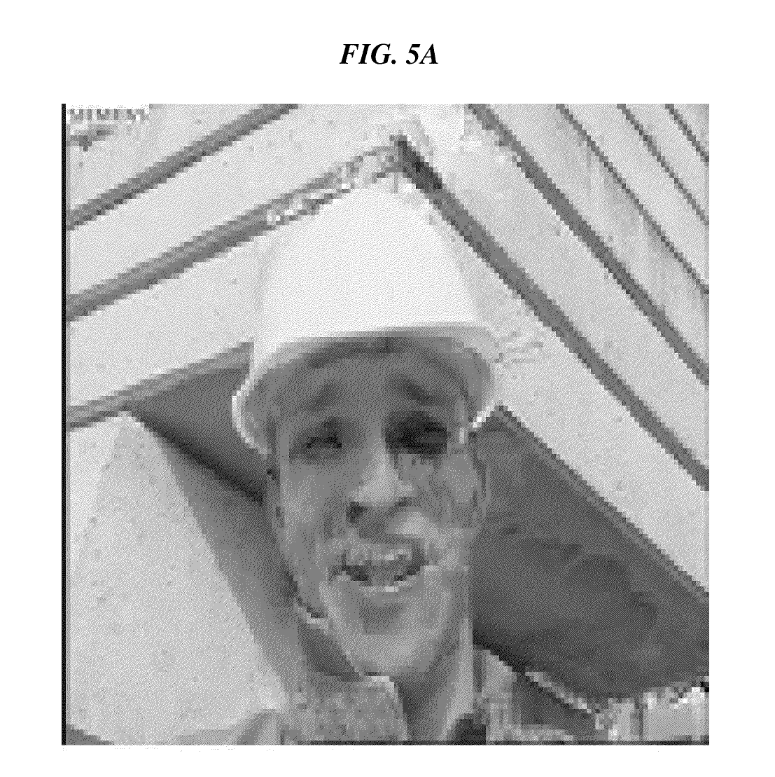

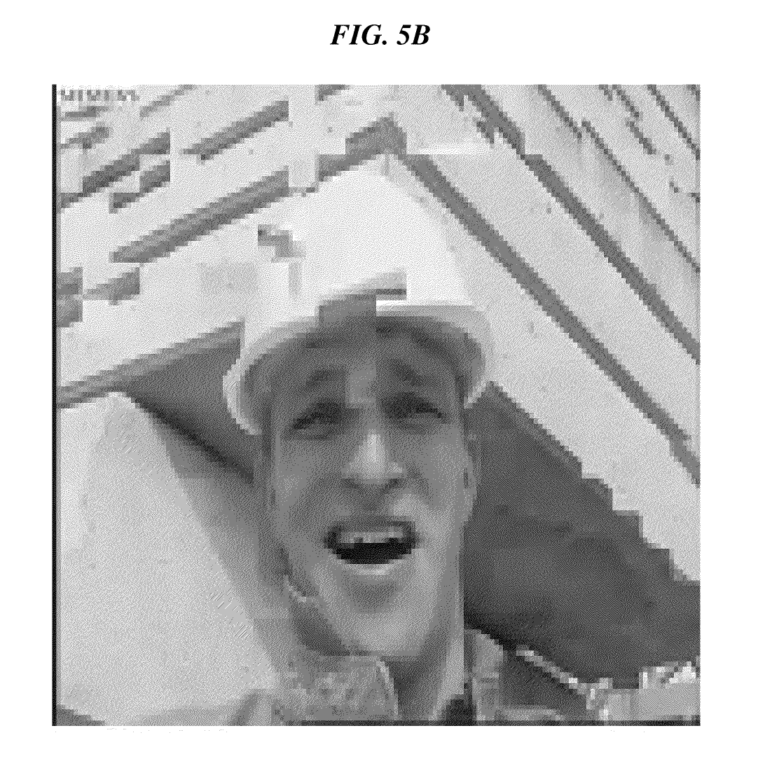

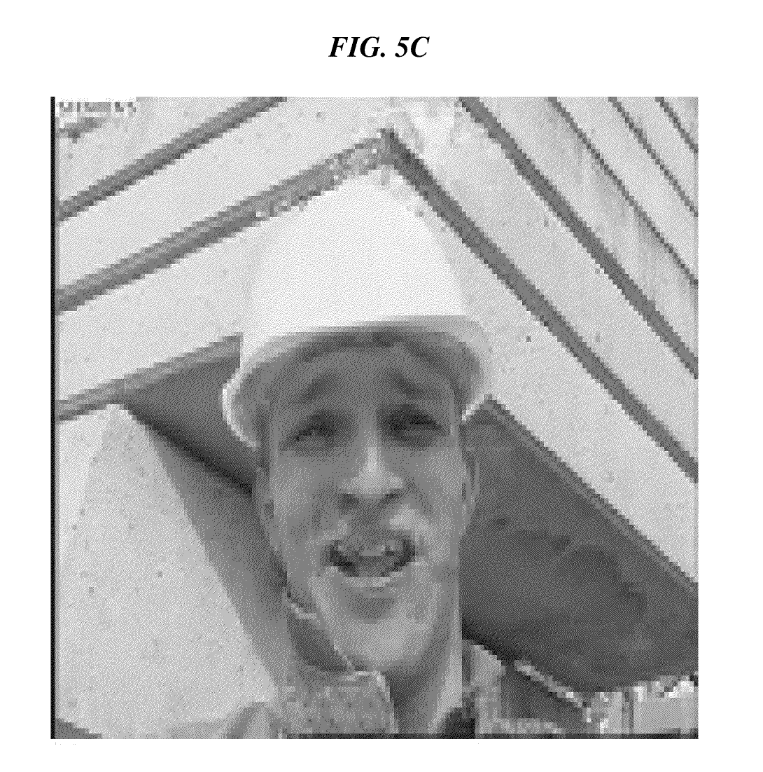

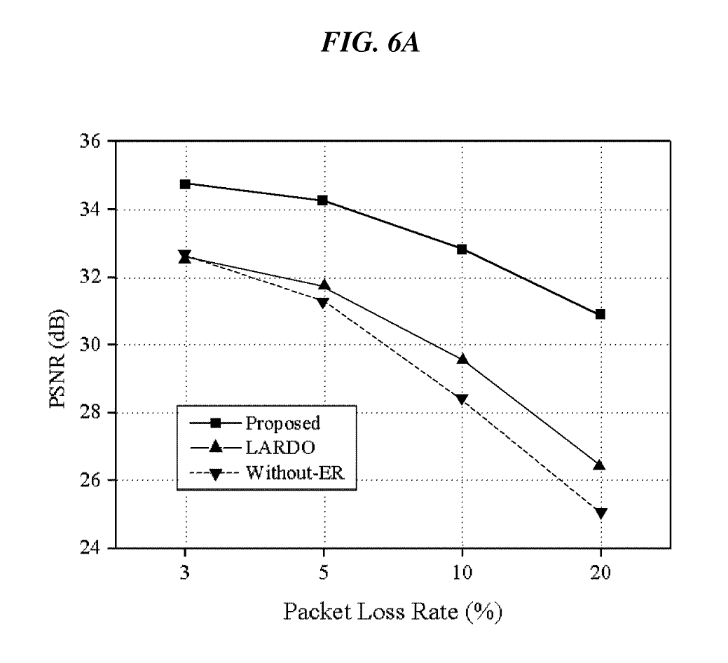

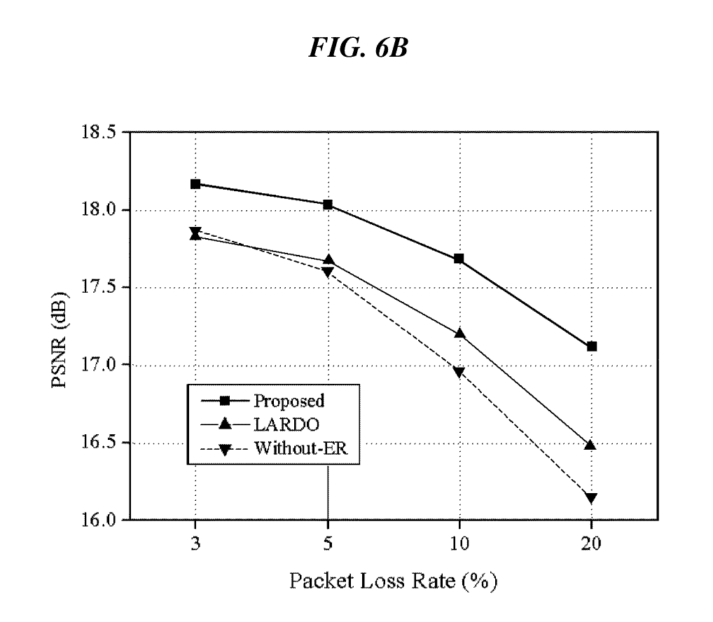

FIG. 1 is a flowchart illustrating an error resilient coding method using adaptive additional image information according to an embodiment of the present invention. FIG. 2 is a view illustrating a construction of a partition when an error resilient coding method according to an embodiment of the present invention is applied to H.264. FIG. 3 is a view illustrating an example where a transmission error of an image is propagated. FIG. 4 is a view illustrating additional image information is configured when an error resilient coding method using adaptive additional image information according to an embodiment of the present invention is applied to H.264. FIGS. 5A, 5B, and 5C are images obtained by application of an error resilient coding method using adaptive additional image information according to an embodiment of the present invention. FIGS. 6A and 6B are graphs illustrating PSNRs obtained by application of an error resilient coding method using adaptive additional image information according to an embodiment of the present invention.

Referring to FIG. 1, an error resilient coding method using adaptive additional image information according to an embodiment of the present invention includes the steps of predicting a distortion of an entire GOP (“group of pictures”) (S1); predicting a distortion of a frame (S3); configuring additional image information (S5); coding and adding the additional image information (S7); and determining whether total information including original image information and the additional image information is within a required amount of data, for example, within a channel capacity range (S9).

A step S10 of determining a priority order of header data includes the steps S1 and S3.

When an embodiment of the present invention is applied to H.264, header data uses partition A. Referring to FIG. 2, data coded based on H.264 includes three independent data partitions, such as partition A 20, partition B 21, and partition C 22.

The partition A 20 includes header data in a slice and header data in macroblocks of the slice. The partition B 21 includes residual data that have been intra-coded or switched intra-coded, and the partition C 22 includes residual data of macroblocks that have been forward and bi-directional inter-coded. Each of the partitions is located in an NAL unit and may be transmitted to an encoder independently from the others.

It is more difficult to restore damaged partition A 20 than the other damaged partitions. The partition A 20 is sensitive to transmission errors. The partition A 20 is inevitable for decoding. Since the partition B 21 and the partition C 22 may be independently decoded, a decoder decodes the partition A 20 and the partition B 21, or the partition A 20 and the partition C 22, and this allows for flexible video transmission over a network that causes errors. Embodiments of the present invention concentrate on coding of additional image information using the partition A 20 that is header data. As used herein, the “additional image information” refers to image information added to original video information upon transmission that is used to restore a distortion of the original video information.

When a partition including header data of a slice and header data in macroblocks of the slice is damaged as an embodiment of the present invention is applied to H.263+++ and MPEG4, each of which uses two types of partitions, a distortion of a frame is predicted to determine priority orders of the header data.

A method of determining priority orders of header data will now be described. For example, the steps S1 and S3 will be described in greater detail.

FIG. 3 illustrates that a transmission error of an image is propagated, wherein original frames in a GOP 30 represent image frames before transmission, and decoded frames in a GOP 31 represent decoded image frames after transmission.

When a transmission error occurs in a GOP, the transmission error is propagated from an inter frame with the transmission error to its subsequent inter frames since inter frames are coded by referring to their previous inter frames. F0 refers to an inter frame in a kth GOP where a transmission error occurs, and Fm refers to a first frame which has a loss in the kth GOP due to the transmission error.

The other frames in the GOP are inter frames. The number of the frames included in the GOP is “L”, that is, the GOP has a length of “L”. In the case of restoring image errors occurring during image compression and image transmission by using an error concealment scheme, for example, three types of distortions may be included, such as distortions caused by source coding, distortions caused by errors of a reference frame, and distortions occurring while restoring errors.

In the case that no transmission errors occur, the overall distortions only include distortions caused by quantization during source coding and distortions present in the reference frame. However, transmission errors generally take place due to channel characteristics. An error concealment scheme for restoring the transmission errors causes a difference between an original image and a decoded image, thus increasing the entire distortions.

A sum Dₜₒₜₐₗ of the entire distortions in the frames from a current primary frame Fₘ to a last frame F_{L-1} in the GOP is defined as a weighted sum of the above three types of distortions:

$$\begin{matrix}{D}_{total} = {\sum }_{i = m}^{L - 1} {D}_{d} ( i ) \\ = {\sum }_{i = m}^{L - 1} \{ ( 1 - P ) [ {D}_{s} ( i ) + {D}_{r} ( i ) ] + {pD}_{c} ( i ) \}\end{matrix} \qquad [ Equation 1 ]$$

Here, D_{d}(i) refers to a sum of entire distortions of an ith frame in a GOP, p refers to a packet loss rate, and Dₛ(i), Dᵣ(i), and D_{c}(i) refer to distortions of the ith frame, which are respectively caused by predictive source coding, by errors of the reference frame, and by error restoration.

Assuming that an image is damaged due to a transmission error and the damaged image is merely replaced by a previous image in the decoder, a distortion Dp(i) of the ith frame due to the transmission error is calculated as in Equation 2:

Dₚ(i)=(1−p)Dᵣ(i)+p[D_{c}(i)+Dₚ(i−1)] [Equation 2]

In Equation 2, Dₚ(i) is a distortion due to error propagation. Therefore, the sum Dₜₒₜₐₗ of the entire distortions is equal to Equation 3:

$${D}_{total} = {\sum }_{i = m}^{L - 1} [ ( 1 - p ) {D}_{s} ( i ) + {D}_{p} ( i ) - {pD}_{p} ( i - 1 ) ] \qquad [ Equation 3 ]$$

Assuming that most of the macroblocks are inter-coded, Dₚ(i) linearly increases as i increases in the GOP. Accordingly, a GOP with a limited length, which is primarily inter-coded, satisfies Equation 4:

Dₚ(i+1)=Dₚ(i)+D_{delta}, 0≦i<L−1 [Equation 4]

D_{delta} is a constant determined by a predictive packet loss rate and characteristics of an inputted video image, and Dₜₒₜₐₗ is equal to Equation 5:

$${D}_{total} = {\sum }_{i = m}^{L - 1} ( 1 - p ) {D}_{s} ( i ) + [ ( L - m ) - p ( L - m - 1 ) ] {D}_{p} ( m ) - {pD}_{p} ( m - 1 ) + \frac{1}{2} [ ( L - m ) ( L - m - 1 ) - p ( L - m - 1 ) ( L - m - 2 ) ] {D}_{delta} \qquad [ Equation 5 ]$$

According to the embodiments of the present invention, D^{x}ₜₒₜₐₗ and D^{o}ₜₒₜₐₗ, respectively, refer to sums of entire distortions of the GOP when a header data loss occurs and when no header data loss occurs. D^{x}ₜₒₜₐₗ and D^{o}ₜₒₜₐₗ, respectively, are represented as in Equations 6 and 7 using Equation 5:

$$\begin{matrix}{D}_{total}^{x} = {\sum }_{i = m}^{L - 1} ( 1 - p ) {D}_{s} ( i ) + [ ( L - m ) - p ( L - m - 1 ) ] {D}_{p}^{x} ( m ) - {pD}_{p}^{x} ( m - 1 ) + \frac{1}{2} [ ( L - m ) ( L - m - 1 ) - p ( L - m - 1 ) ( L - m - 2 ) ] {D}_{delta} & [ Equation 6 ] \\ {D}_{total}^{o} = {\sum }_{i = m}^{L - 1} ( 1 - p ) {D}_{s} ( i ) + [ ( L - m ) - p ( L - m - 1 ) ] {D}_{p}^{o} ( m ) - {pD}_{p}^{o} ( m - 1 ) + \frac{1}{2} [ ( L - m ) ( L - m - 1 ) - p ( L - m - 1 ) ( L - m - 2 ) ] {D}_{delta} & [ Equation 7 ]\end{matrix}$$

Distortions of the entire GOP when a header data loss occurs and when no header data loss occurs may be predicted in step S1 using Equations 6 and 7.

In Equations 6 and 7, D^{p}ₚ(m) and D^{x}ₚ(m), respectively, refer to error propagated distortions when a head data loss occurs and when no head data loss occurs in a case where an mth frame is the current primary frame of the GOP.

In general, a mean square error (“MSE”) or a peak signal to noise ratio (“PSNR”) is used as a distortion value. According to an embodiment, PSNR values are used for distortion values. Since header data of a frame Fₘ₋₁ which is a previous frame of the current primary frame Fₘ does not affect a distortion of the current primary frame, Equation 8 is established:

Dₚ^{x}(m−1)=Dₚ^{o}(m−1) [Equation 8]

Predicted error values are modeled as in Equation 9 by using Equations 6, 7, and 8:

$$\begin{matrix}Δ {D}_{total} ( m ) = {D}_{total}^{o} - {D}_{total}^{x} \\ = ( L - m ) Δ {D}_{p} ( m ) - ( L - m - 1 ) p Δ {D}_{p} ( m ) \\ = [ L - m - p ( L - m - 1 ) ] Δ {D}_{p} ( m )\end{matrix} \qquad [ Equation 9 ]$$

Accordingly, in step S3, distortions (ΔDₜₒₜₐₗ(m)) of frames whose header data are damaged are calculated and header data are sorted in a descending order of the distortions (ΔDₜₒₜₐₗ(m)), so that priority orders of the header data may be determined.

A method of determining priority orders additionally considering the size of header data will now be described.

A limited channel capacity renders it difficult to additionally transmit header data of the whole frames in a GOP over a network. Accordingly, it is required to minimize the amount of additional image information while maintaining the quality of a decoded video.

According to an embodiment, when determining priority orders of header data of frames in additional image codes, a higher priority order is assigned to a smaller size of header data. For example, two factors, such as distortions of frames with a header data loss and the size of header data, are considered to determine a priority order of each header data. A final priority order is determined by Equation 10:

$$O ( m ) = \frac{Δ {D}_{total} ( m )}{R ( m )} \qquad [ Equation 10 ]$$

R(m) refers to the number of coded bits of header data of an mth frame. Final additional image information are generated by including the head data of frames, which are sorted according to the determined priority orders by a predetermined additional information bit rate.

Table 1 as below shows priority orders of head data that are obtained by predicting distortions (ΔDₜₒₜₐₗ(m)) of frames with a head data loss and by considering the size of the header data:

TABLE 1

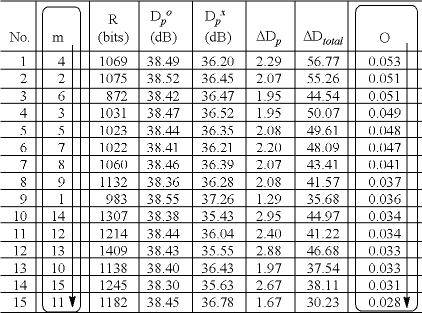

In Table 1, “m” refers to a frame number, ΔDₜₒₜₐₗ is a distortion of an mth frame that is calculated by Equation 9, and “O” refers to a result calculated by Equation 10.

In step S10, priority orders of header data may be determined based on “O” which are results obtained by considering distortions of frames with a header data loss and the size of the header data. For example, according to an embodiment, header data with a higher O value may have a higher priority order.

In step S5 of configuring additional image information, additional image information is configured based on the priority orders of the header data that was determined in step S10.

FIG. 4 illustrates header data of additional image information that are configured according to priority orders according to an embodiment of the present invention. Referring to FIG. 4, additional image information, such as a redundant picture code 41, in which the header data are sorted according to the priority orders determined in Table 1 is added to original image information, such as an original picture code 40. According to Table 1, the header data have priority orders of “header 4, header 2, header 6, . . . , and header 11”. As a consequence, the additional image information 41 is configured to have an order of “header 4, header 2, header 6, . . . , and header 11”, as shown in FIG. 4.

In step S7, the additional image information in which the header data are sorted in the priority orders is coded and the coded additional image information is added to original image information. According to an embodiment, when adding the coded additional image information to the original image information, the amount of the additional image information may be adjusted in consideration of a channel capacity.

According to an embodiment, the additional image information may be configured considering the channel capacity before coded and added to the original image information.

In step S9, when the total information including the original image information and the additional image information exceeds a predetermined channel capacity, step S7 is performed again so that the total information does not exceed the predetermined channel capacity. When the total image information is not in excess of the channel capacity, the image information is subjected to transmission.

FIG. 5A is a view illustrating an image to which no image processing method has been applied, FIG. 5B is a view illustrating an image to which an LARDO method has been applied, and FIG. 5C is a view illustrating an image to which an error resilient coding method according to an embodiment of the present invention has been applied. Referring to FIGS. 5A, 5B, and 5C, the image in FIG. 5A experiences a serious distortion. The quality of the image in FIG. 5B is made better than that of the image in FIG. 5A. Among the three images in FIGS. 5A, 5B, and 5C, the image in FIG. 5C exhibits the best quality with the least distortion.

FIGS. 6A and 6B are graphs illustrating PSNR values of images which were subjected to no image processing, an LARDO method, and an error resilient coding method according to an embodiment of the present invention, wherein FIG. 6A illustrates PSNR values when QP=26, additional image information rate is 2.5%, and image format is CIF, and FIG. 6B illustrates PSNR values when QP=26, additional image information rate is 2.5%, and image format is QCIF.

Thick solid lines indicate values obtained by application of an error resilient coding method according to an embodiment of the present invention, thin solid lines indicate values obtained by application of an LARDO method, and dotted lines indicate values obtained when no image processing is applied to the images.

It can be seen from FIGS. 6A and 6B that most serious distortions are exhibited when no image processing method is applied to the images with the lowest PSNR values, and higher PSNR values are obtained when the LARDO method is applied to the images than when no image processing method is applied to the images, thus showing lower distortions. Further, when the error resilient coding method is applied to the images, it can be seen that the images are least distorted with the highest PSNR values.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An error resilient coding method using adaptive additional image information, comprising:
determining a priority order of header data;
adaptively configuring additional image information according to the priority order; and
coding the additional image information and adding the coded additional image information to original image information.

2. The method of claim 1, further comprising:
determining whether the image information exceed a predetermined amount of data.

3. The method of claim 1, wherein determining the priority order of header data includes predicting a distortion of an entire group of pictures (“GOP”).

4. The method of claim 3, wherein determining the priority order of header data is performed by predicting a distortion of a frame using a result of a predicted distortion of the entire GOP.

5. The method of claim 4, wherein the distortion of the frame is predicted based on a following equation:
ΔDₜₒₜₐₗ(m)=[L−m−p(L−m−1)]ΔDₚ(m) (where, m refers to a frame number, L refers to the number of frames included in a GOP, p refers to a packet loss rate, and ΔDₚ(m) refers to a distortion of an mth frame due to error propagation, and ΔDₜₒₜₐₗ(m) refers to a distortion of the mth frame), wherein
the priority order of the header data is determined according to a size of the predicted distortion.

6. The method of claim 4, wherein determining the priority order of the header data includes predicting O(m) based on a following equation:
$$O ( m ) = \frac{Δ {D}_{total} ( m )}{R ( m )}$$
(where, ΔDₜₒₜₐₗ(m) refers to a distortion of the mth frame, R(m) refers to the number of coded bits of header data in the mth frame, and O(m) refers to Dₜₒₜₐₗ(m) with respect to R(m)), wherein a higher O(m) value has a higher priority order of the header data.

7. The method of claim 1, wherein coding the additional image information and adding the coded additional image information to original image information includes adjusting the amount of the additional image information to be within a channel capacity range.
